(19) United States
(12) Patent Application Publication
(10) Pub. No.: US 2024/0360668 A1
(43) Pub. Date: Oct. 31, 2024

(54) COMPOSITION AND METHOD FOR PRODUCTION OF A 3D PRINTED EARTH WALLS, NOZZLE AND MIXING SYSTEM FOR 3D PRINTING DEVICE PERFORMING SAID METHOD

(71) Applicants: Hamed Niroumand, Tehran (IR); Lech Balachowski, Gdansk (PL)

(72) Inventors: Hamed Niroumand, Tehran (IR); Lech Balachowski, Gdansk (PL)

(21) Appl. No.: 18/141,379

(22) Filed: Apr. 29, 2023

(51) Int. Cl. E04B 2/84; B33Y 10/00; B33Y 30/00

(52) U.S. Cl. CPC E04B 2/84; B33Y 10/00; B33Y 30/00; B33Y 80/00

(57) ABSTRACT

A method for production of a 3D printed earth wall includes steps of:
a) preparing a building composition (1), b) preparing a construction area (2), c) compacting the building composition (1), d) providing the building composition (1) in a form of an elastic rod (R) forming a first layer (L₁) of the 3D printed earth wall (3) to the predetermined construction area (2) by a 3D earth wall printing device (4), e) repeating step d) for building further layers (L₂ to L_{X}) of the 3D printed earth wall (3) according to a specific construction design, f) curing the constructed printed earth wall (3), wherein the cross section of the rod (R) forming each layer of the building composition (1) is substantially rectangular. The nozzle for a 3D earth wall printing device comprises an inlet end (16) and a compacting end (17), wherein the compacting end (17) has a tapering shape which, together with the building composition (1) being supplied at an equivalent pressure (based on standard and modified Proctor tests), allows for a compaction of the building composition (1) during applying. The mixing system for a 3D earth wall printing device is configured to mix and homogenize the building composition (1) inside the mixing channel (20) using the mixing member (21), provide a homogeneous building composition (1) and to output the mixed homogeneous building composition (1) through the nozzle (15).

### BACKGROUND OF THE INVENTION

### Field of the Invention

The present disclosure generally relates to materials engineering, and more particularly to a composition and method for production of a 3D printed earth walls for houses, buildings and similar structures, a nozzle and a mixing system for a 3D printing device performing said method.

### Brief Description of the Background of the Invention Including Prior Art

Soil stabilization is a subset of soil improvement methods. The soil stabilization is defined as a chemical, physical, biological, mechanical, or combined technique that maintains or improves the stability of weak soils to achieve engineering goals. One of such goals is providing earth walls and earth houses with a method of 3D printing. Chinese utility model CN214364241U provides a prestressed rammed earth building wall which comprises a U-shaped mounting frame, two restraining plates which are symmetrically arranged at the bottom of the inner side face of the mounting frame, wherein vertical positioning plates are arranged in the two restraining plates, and the mounting frame is filled with a rammed earth layer. The rammed earth layer comprises a first rammed earth layer, a second rammed earth layer, a third rammed earth layer and a fourth rammed earth layer which are sequentially arranged in the mounting frame from bottom to top, and the positioning plate is located in the middles of the first rammed earth layer, the second rammed earth layer, the third rammed earth layer and the fourth rammed earth layer. Chinese utility model CN211229015U discloses an assembly type rammed earth wall which comprises a plurality of rammed earth wall plates, connecting columns and steel angle corner. The rammed earth wall plates are sequentially connected through the connecting columns, and the rammed earth wall plates at the corners of the rammed earth wall are connected through angle steel. The rammed earth wallboard comprises a first outer fixing plate and a second outer fixing plate, and a rammed earth filling layer is arranged in the middle. Chinese utility model CN211114301U provides a rammed earth curtain wall with a pre-buried sleeve, which comprises a support structure, the support structure comprises a mounting stand column, and the mounting stand column is vertically mounted on the outer surface of a building; wherein a plurality of rammed earth building block hanging pieces are arranged on the mounting stand column, each rammed earth building block hanging piece comprises a first part and a second part, the first parts are tightly mounted on the mounting stand column, and the second parts are perpendicular to the first parts; the panel structure is formed by mutually stacking rammed earth building blocks, and each rammed earth building block is provided with a first end part, a second end part, a third end part and a fourth end part. KR102333574B1 relates to a 3D printing device for building capable of rapidly moving a spray nozzle by simplifying a transfer system and easily dealing with clogging of a spray nozzle according to use of cement printing materials. The 3D printing device for building comprises: a pair of Y direction rails installed side by side to have a predetermined height to be spaced from the ground; an X direction rail movably installed in an Y direction along the Y direction rail in a state that both ends of the X direction rail expend in the pair of Y direction rails; a first moving member movably installed in an X direction along the X direction rail; a second moving member installed in a Z direction to be lifted to be supported by the first moving member; a nozzle member installed at a bottom end of the second moving member so that height of the nozzle member is adjusted by elevation of the second moving member, and including a hopper for temporarily receiving a printing material to spray the printing material downward by a spray nozzle formed at a bottom end, and a stirring blade installed in the hopper and rotating to stir and extrude the printing material.

The known methods of production of the printed earth walls for the earth buildings are time consuming, they require significant amount of dedicated equipment and therefore they are relatively expensive. The execution time also depends on the availability of the construction materials at the construction site. The construction materials have to be transported from a warehouse what involves transportation costs. Some of the construction materials, for example the chemical components used for the chemical stabilization method, are available only at the specialized warehouses which are usually far away from the construction site. It requires providing the construction materials to the construction site in advance and in excess, what additionally increases the costs. The chemical components are also not environmental friendly, what can create a significant problem in the areas with underground water courses. The nozzle member known from the KR102333574B1 is round. This nozzle member during the production process creates a concrete layer which in the cross section is round. The round layers when put one on top the other creates only a partial connection between the layers as compared to the full width of the wall, which is not as strong as it could be if the connection in the cross section of the wall was substantially full.

### SUMMARY OF THE INVENTION

### Purposes of the Invention

It is an object of the present invention to provide a method of building printed earth walls for an earth buildings as a type of earthen building technique, which is environmental friendly (so called “sustainable”, “green” and “vernacular”), involves significantly less resources as compared to the methods known from the prior art and therefore is faster and cheaper. It is another object of this invention to provide a nozzle member for the 3D printing device in order to build the earth walls and houses, which walls create substantially full connection between the produced layers of the printed earth wall. It is another object of the present invention to provide an improved mixing system for the 3D printing device for building the earth walls and houses. These and other objects and advantages of the present invention will become apparent from the detailed description, which follows.

### BRIEF DESCRIPTION OF THE INVENTION

The object of the invention is to provide a method for production of a 3D printed earth walls for an earth buildings, wherein the method includes steps of:
a) preparing a building composition,
b) preparing a construction area,
c) compacting the building composition,
d) providing the building composition in a form of an elastic rod forming a first layer of the 3D printed earth wall to the predetermined construction area by a 3D earth wall printing device,
e) repeating step d) for building further layers of the 3D printed earth wall according to a specific construction design, wherein each subsequent layer is positioned on top of the previous layer in a vertical direction,
f) curing the printed earth wall,
wherein the cross section of the rod forming each layer of the building composition is substantially rectangular. By the wording “substantially rectangular” in this application it is meant that the shape of the cross section in general is similar to a rectangular or in specific case to a square. The real figure of the cross section of the rod forming each layer may differ from the theoretical rectangular in that it can have rounded corners and the lines forming the real sides of the cross section can deviate slightly from the lines of the theoretical rectangular.

The building composition can include Micro-Additives (MA), Micro Green-Additives (MGA), Green Soil-Improvement (GSI), Green Ground-Improvement (GGI), Nano Green-Additives (NGA), Nano-Additives (NA), Bio-Additives (BA), Nano-Bio Additives (NBA), Nano Soil-Improvement (NSI), Nano Ground-Improvement (NGI), and etc. By “nano” in this application is meant that the size of the majority of the particles of the respective additive is in the range of 10-150 nm. By majority it is meant more than 50%.

The 3D wall printing device is a device known from prior art. It can be any kind of the device, including device positioned on a frame or a device in form of a gigantic robotic arm positioned in a center or outside of the constructed building.

The building composition can be prepared from various type of soils, preferably from the soils available on or close to the construction site. It means that “green”, “sustainable”, and “vernacular” materials can be used for this purpose, which means that the materials are environmental friendly.

Preparing the construction area is regarded as a standard earth works connected to preparing and/or flattening the ground for the construction of a building and/or any other structure, with or without foundations. This type of structure can be used for temporary houses, heritage restoration, villages, tourism zones, buildings and etc. Each rod of the layers comprises a bottom part, top part and two sides, wherein each of the bottom part of the layers is bound to the top part of the adjacent layers respectively, forming a permanent joint. The permanent joint created by the bottom part of one layer with the top part of the adjacent layer is created by merging the material of the building composition such that there is substantially no boundary between the building composition materials from the both layers. In another words, in the place of the joint the particles of one layer diffuse to the adjacent layer and vice versa. It creates an interface area with a continuous structure without reducing any of the mechanical properties of the original building composition material.

The bottom part has a first size and the top part has a second size, measured perpendicular to the 3D printed earth wall respectively, wherein the first size is substantially equal to the second size. By “substantially equal” in this application it is meant that the sizes can slightly differ from each other, preferably up to 15%. The joint has a third size, measured perpendicular to the 3D printed earth wall, wherein the third size preferably equals at least 80% of the first size and the second size.

Each cross section of the bar has a middle size, measured horizontally at the middle of the bar, wherein the middle size is preferably no more than 120% of the third size.

Another object of the invention is to provide a nozzle for a 3D earth wall printing device. The nozzle comprises an inlet end and a compacting end, wherein the compacting end has a tapering shape which, together with the building composition being supplied at an equivalent pressure based on standard and modified Proctor tests, for a compaction of the building composition during applying, forming the rod of the layer of the 3D printed earth wall. The compacting end includes at least two forming protrusions. The forming protrusions extend outwardly from the compacting end, preferably perpendicular to the surface of the top part of the layers. The forming protrusions are configured to shape the sides of the rod of the building composition, during applying, preferably to a substantially flat shape of the sides, and to restrain the building composition, supplied under pressure, from extending the middle size more than preferably 10% of the first size and the second size, perpendicular to the 3D printed earth wall before the building composition is cured. The equivalent pressure under which the building composition is supplied by the compacting end is preferably standard and modified Proctor compaction tests, and are detailed in ASTM D698, AASHTO T 99, ASTM D1557 and AASHTO T 180 test methods. The Proctor compaction test is a laboratory method of experimentally determining the optimal moisture content at which a given soil type will become most dense and achieve its maximum dry density. The original test is most commonly referred to as the standard Proctor compaction test; this test was later updated to create the modified Proctor compaction test. The steps of this test are: 1. Weighting the empty mold; 2. Recording the mold's height and diameter; 3. Transferring the soil into the large mixing pan; 4. Calculating the amount of a water to be added to the soil in the mixing pan; 5. Pouring the water into the spray container; 6. Spraying the water onto the soil in the mixing pan; 7. Securing the collar back on the mold; 8. Placing some of the soil in the compaction mold; 9. Setting the compaction mold on a hard flat surface; 10. Using a Proctor hammer to compact the compaction mold; 11. Scarifying the surface of the sample; 12. Adding more soil on the top of the soil in the compaction mold; 13. Repeating steps 9 and 10; 14. Removing the collar; 15. Using a straightedge to trim excess soil; 16. Weighting the mold without the collar; 17. Extracting the sample from the mold; 18. Cutting the compacted soil with a knife; 19. Weighting the soil pieces from the top and bottom; 20. Placing the cans in the drying oven for 24 hours.

The Proctor hammer can be replaced by applying a pressure with a piston driven by a pressure created by a hydraulic pomp.

Another object of the invention is to provide a mixing system for a 3D earth wall printing device. The mixing system includes a mixing channel, a nozzle, a mixing member and a driving member. The mixing channel includes an inlet end and an output end, wherein the output end is connected in fluid communication with the nozzle. The mixing channel houses the mixing member, which is motorized by the driving member mounted on bearings. The bearings can be of any type, for example ball or plain bearings. The mixing system is configured to receive the batch building composition at the inlet end, mix and homogenize the building composition inside the mixing channel using the mixing member, provide a homogeneous building composition and to output the mixed homogeneous building composition through the nozzle. The homogenization of the building composition creates a unique properties of the building composition.

### BRIEF DESCRIPTION OF THE DRAWINGS

These aims together with other objects and advantages which will become subsequently apparent reside in the details of the construction and operation as more fully hereinafter described and claimed, reference being made to the accompanying drawings forming a part hereof, wherein the same numerals refer to the same parts throughout.

In drawings

FIG. 1 illustrates schematically the process of building the 3D printed earth wall by using the 3D wall printing device equipped with the mixing system and a nozzle according to the invention for the 3D earth wall printing device,

FIG. 2 illustrates schematically the cross section of the two adjacent layers L₁ and L₂ of the printed earth wall,

FIG. 3 illustrates schematically a perspective view of the nozzle according to the invention for the 3D earth wall printing device,

FIG. 4 illustrates schematically a perspective view of the mixing system according to the invention for the 3D earth wall printing device.

### DETAILED DESCRIPTION OF THE INVENTION AND PREFERRED EMBODIMENT

Referring to the drawing, FIG. 1 shows schematically a method for production of the 3D printed earth wall. The method includes steps of:
a) preparing a building composition 1,
b) preparing a construction area 2,
c) compacting the building composition 1 in the mixing device,
d) providing the building composition 1 in a form of an elastic rod R forming a first layer L₁ of the 3D printed earth wall 3 to the predetermined construction area 2 by a 3D earth wall printing device 4,
e) repeating step d) for building further layers L₂ to L_{X} of the 3D printed earth wall 3 according to a specific construction design, wherein each subsequent layer L_{X} is positioned on top of the previous layer L_{X-1} in vertical direction,
f) curing the constructed printed earth wall 3,
Wherein the cross section of the rod R forming each layer of the building composition 1 is substantially rectangular.

The building composition (called also a mud) is prepared from the soil available at the construction site. The soil is mixed with additives, and water. The additives can include Micro-Additives, Micro Green-Additives (GA), Nano Green-Additives (NGA), Nano-Additives (NA), Bio-Additives (BA), Nano-Bio Additives (NBA), Green Soil-Improvement (GSI), Green Ground Improvement (GGI), Nano Soil-Improvement (NSI), Nano Ground-Improvement (NGI), and etc.

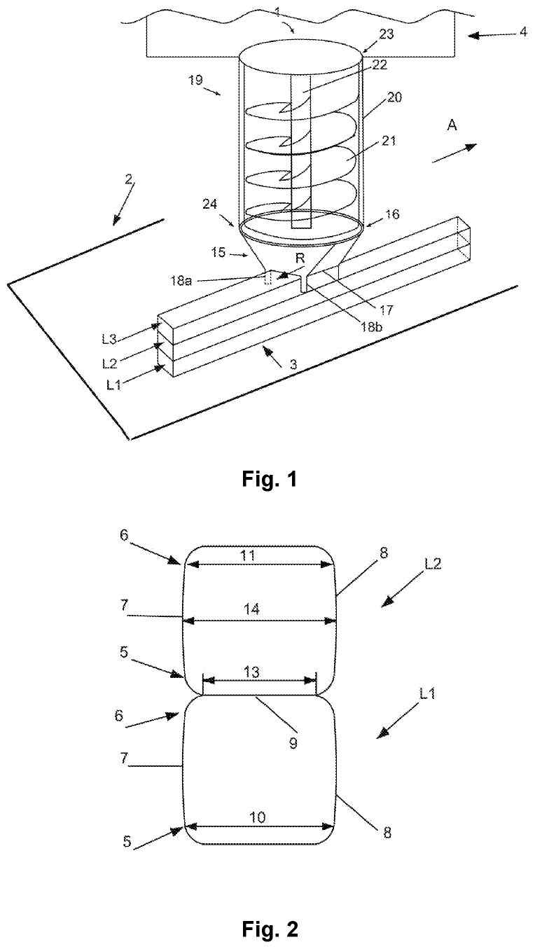

FIG. 2 shows schematically two adjacent rods R, wherein each rod R of the layers L₁-L_{X} comprises a bottom part 5, top part 6 and two sides 7, 8. Each of the bottom part 5 of the layers L₂ to L_{X} is bound to the top part (6) of the adjacent layers L₁ to L_{X-1} respectively, forming a permanent joint 9 at the interface area.

The bottom part 5 has a first size 10 and the top part 6 has a second size 11, measured perpendicular to the outer or inner surface of the 3D printed earth wall 3 respectively. The first size 10 is substantially equal to the second size 11. The joint 9 has a third size 13, measured perpendicular to the outer or inner surface of the 3D printed earth wall 3. The third size 13 in one embodiment, as measured, equals in average 80% of the first size 10 and the second size 11.

Each cross section of the rod R has a middle size 14, measured horizontally at the middle of the rod R, wherein the middle size 14, as measured, equals in average 120% of the third size 13.

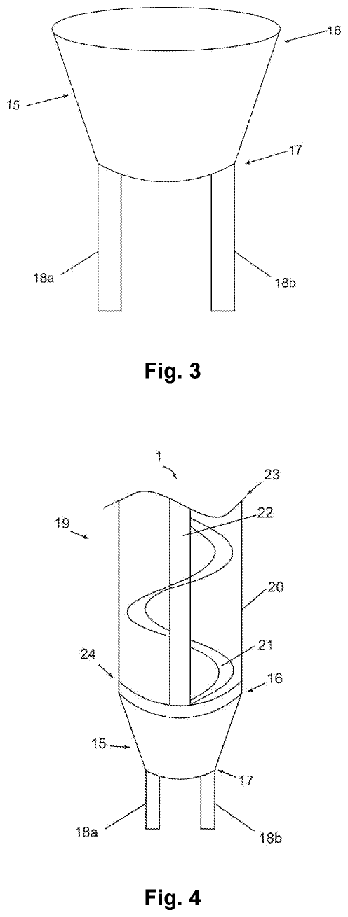

FIG. 3 shows schematically the nozzle for the 3D earth wall printing device. The nozzle 15 comprises an inlet end 16 and a compacting end 17, wherein the compacting end 17 has a tapering shape which, together with the building composition 1 being supplied at a pressure, allows for a compaction of the building composition 1 during applying, forming the rod R of the layer L₁ to L_{X} of the 3D printed earth wall (3). According to standard and modified Proctor tests, an equivalent pressure use as compaction pressure. The compacting end 17 includes at least two forming protrusions 18a, 18b. The forming protrusions 18a, 18b extend outwardly from the compacting end 17, configured to shape the sides 7, 8 of the rod R of the building composition 1, during applying, to a substantially flat shape of the sides 7, 8, and to restrain the building composition 1, supplied under pressure, from extending the middle size 14 more than 15% of the first size 10 and the second size 11, perpendicular to the 3D printed earth wall 3 before the building composition 1 is cured. In one embodiment, the size 14 extends in average 8% behind the first size 10 and the second size 11. According to various types of the mud and the soil compositions and the printed walls thicknesses, the nozzles can be different in sizes. The sizes of the nozzles are determined experimentally.

FIG. 4 shows schematically a mixing system for the 3D earth wall printing device. The mixing system 19 includes a mixing channel 20, a nozzle 15, a mixing member 21 and a driving member 22. The mixing channel 20 includes an inlet end 23 and an output end 24. The output end 24 is connected in fluid communication with the nozzle 15. The mixing channel 20 houses the mixing member 21, which is motorized by the driving member 22 mounted on bearings. The bearings are standard ball bearings. The mixing system 19 is configured to receive the batch building composition 1 at the inlet end 23, mix and homogenize the building composition 1 inside the mixing channel 20 using the mixing member 21, provide a homogeneous building composition 1 and to output the mud as the mixed homogeneous building composition 1 through the nozzle 15. The physical effect of the homogenization is obtained by the mixing member 21. The specific mechanical properties of the homogenization and equivalent pressure created by the pomp supplying the building composition 1 at the inlet end 23 are important for maintaining the rectangular shape of the rod R substantially not changing from the time of applying to the curing.

In describing a preferred embodiment of the invention, specific terminology is resorted to for the sake of clarity. However, the invention is not intended to be limited to the specific terms so selected, and it is to be understood that each specific term includes all technical equivalents which operate in a similar manner to accomplish a similar purpose.

What is claimed is:

1. A method for production of a 3D printed earth walls for an earth buildings, wherein the method includes steps of:
a) preparing a building composition (1),
b) preparing a construction area (2),
c) compacting the building composition (1),
d) providing the building composition (1) in a form of an elastic rod (R) forming a first layer (L₁) of the 3D printed earth wall (3) to the predetermined construction area (2) by a 3D earth wall printing device (4),
e) repeating step d) for building further layers (L₂ to L_{X}) of the 3D printed earth wall (3) according to a specific construction design, wherein each subsequent layer (L_{X}) is positioned on top of the previous layer (L_{X-1}) in vertical direction,
f) curing the 3D printed earth wall (3),
wherein the cross section of the rod (R) forming each layer of the building composition (1) is substantially rectangular.

2. Method of production of the 3D printed earth wall (3) according to claim 1, wherein each rod (R) of the layers (L₁-L_{X}) comprises a bottom part (5), top part (6) and two sides (7, 8), wherein each of the bottom part (5) of the layers (L₂ to L_{X}) is bound to the top part (6) of the adjacent layers (L₁ to L_{X-1}) respectively, forming a permanent joint (9).

3. Method of production of the 3D printed earth wall according to claim 2, wherein the bottom part (5) has a first size (10) and the top part (6) has a second size (11), measured perpendicular to the 3D printed earth wall (3) respectively, wherein the first size (10) is substantially equal to the second size (11), and the joint (9) has a third size (13), measured perpendicular to the 3D printed earth wall (3), wherein the third size (13) equals at least 80% of the first size (10) and the second size (11).

4. Method of production of the 3D printed earth wall according to claim 2, wherein each cross section of the bar (B) has a middle size (14), measured horizontally at the middle of the bar (B), wherein the middle size (14) is no more than 120% of the third size (13).

5. A nozzle for a 3D earth wall printing device, wherein the nozzle (15) comprises an inlet end (16) and a compacting end (17), wherein the compacting end (17) has a tapering shape which, together with the building composition (1) being supplied at an equivalent pressure based on standard and modified Proctor tests, allows for a compaction of the building composition (1) during applying, forming the rod (R) of the layer (L₁ to L_{X}) of the 3D printed earth wall (3), wherein the compacting end (17) includes at least two forming protrusions (18a, 18b), wherein the forming protrusions (18a, 18b) extend outwardly from the compacting end (17), configured to shape the sides (7, 8) of the rod (R) of the building composition (1), during applying, to a substantially flat shape of the sides (7, 8), and to restrain the building composition (1), supplied under pressure, from extending the middle size (14) more than 10% of the first size (10) and the second size (11), perpendicular to the 3D printed earth wall (3) before the building composition (1) is cured.

6. A mixing system for a 3D earth wall printing device, wherein the mixing system (19) includes a mixing channel (20), a nozzle (15), a mixing member (21) and a driving member (22), wherein the mixing channel (20) includes an inlet end (23) and an output end (24), wherein the output end (24) is connected in fluid communication with the nozzle (15), wherein the mixing channel (20) houses the mixing member (21), which is motorized by the driving member (22) mounted on a bearings, wherein the mixing system (19) is configured to receive the batch building composition (1) at the inlet end (23), mix and homogenize the building composition (1) inside the mixing channel (20) using the mixing member (21), provide a homogeneous building composition (1) and to output the mixed homogeneous building composition (1) through the nozzle (15).
